(19) United States
(12) Patent Application Publication
(10) Pub. No.: US 2012/0036468 A1
(43) Pub. Date: Feb. 9, 2012

(54) USER INPUT REMAPPING

(75) Inventor: Ashley Colley, Oulu (FI)

(73) Assignee: Nokia Corporation, Espoo (FI)

(21) Appl. No.: 12/849,589

(22) Filed: Aug. 3, 2010

(51) Int. Cl. G06F 3/048

(52) U.S. Cl. 715/773

(57) ABSTRACT

An apparatus and method for receiving an input at a first location on an input-sensing surface, the first location being mapped to the activation of a first user interface component; receiving a correction of the activation to the activation of a second user interface component; and based at least in part on the correction, remapping subsequent inputs within a locus to the activation of the second user interface component.

### TECHNICAL FIELD

The present application relates generally to the remapping of user inputs made on an input-sensing surface.

### BACKGROUND

User input entered at locations on an input-sensing surface may be incorrect if the user erroneously enters the input at the wrong location.

### SUMMARY

According to a first example, there is provided a method comprising: receiving an input at a first location on an input-sensing surface, the first location being mapped to the activation of a first user interface component; receiving a correction of the activation to the activation of a second user interface component; and based at least in part on the correction, remapping subsequent inputs within a locus to the activation of the second user interface component.

According to a second example, there is provided an apparatus comprising: a processor; and memory including computer program code, the memory and the computer program code configured to, working with the processor, cause the apparatus to perform at least the following: receive an input at a first location on an input-sensing surface, the first location being mapped to the activation of a first user interface component; receive a correction of the activation to the activation of a second user interface component; and based at least in part on the correction, remap subsequent inputs within a locus to the activation of the second user interface component.

According to a third example, there is provided a computer program product comprising a computer-readable medium bearing computer program code embodied therein for use with a computer, the computer program code comprising: code for receiving an input at a first location on an input-sensing surface, the first location being mapped to the activation of a first user interface component; code for receiving a correction of the activation to the activation of a second user interface component; and code for, based at least in part on the correction, remapping subsequent inputs within a locus to the activation of the second user interface component.

According to a fourth example, there is provided an apparatus comprising: means for receiving an input at a first location on an input-sensing surface, the first location being mapped to the activation of a first user interface component; means for receiving a correction of the activation to the activation of a second user interface component; and means for, based at least in part on the correction, remapping subsequent inputs within a locus to the activation of the second user interface component.

### BRIEF DESCRIPTION OF THE DRAWINGS

For a more complete understanding of example embodiments of the present invention, reference is now made to the following descriptions taken in connection with the accompanying drawings in which:

FIG. 1 is an illustration of an apparatus;

FIG. 2 is an illustration of an example of a display on a touchscreen;

FIG. 3 is an illustration of a portion of the display of FIG. 2 superimposed with representations of activation areas;

FIG. 4 is an illustration of a portion of the display of FIG. 2 superimposed with representations of activation areas;

FIG. 5 is an illustration of the display portion of FIG. 4 further superimposed with representations of user inputs;

FIG. 6 is an illustration of the display portion of FIG. 4 further superimposed with representations of user inputs, and in which the activation areas have been modified;

FIG. 7 is an illustration of a portion of the display of FIG. 2 superimposed with representations of activation areas and user inputs;

FIG. 8 is an illustration of the display portion of FIG. 7 in which the activation areas have been modified;

FIG. 9 is an illustration of the display portion of FIG. 7 superimposed with a representation of input densities over a first threshold;

FIG. 10 is an illustration of the display portion of FIG. 7 superimposed with a representation of input densities over a second, higher, threshold;

FIG. 11 is an illustration of the display portion of FIG. 10 in which the activation areas have been modified;

FIG. 12 is an illustration of the display portion of FIG. 10 in which the activation areas have been differently modified;

FIG. 13 is an illustration of the display portion of FIG. 3 in which the activation areas have been translated;

FIG. 14 is a flow chart illustrating a method.

### DETAILED DESCRIPTION OF THE DRAWINGS

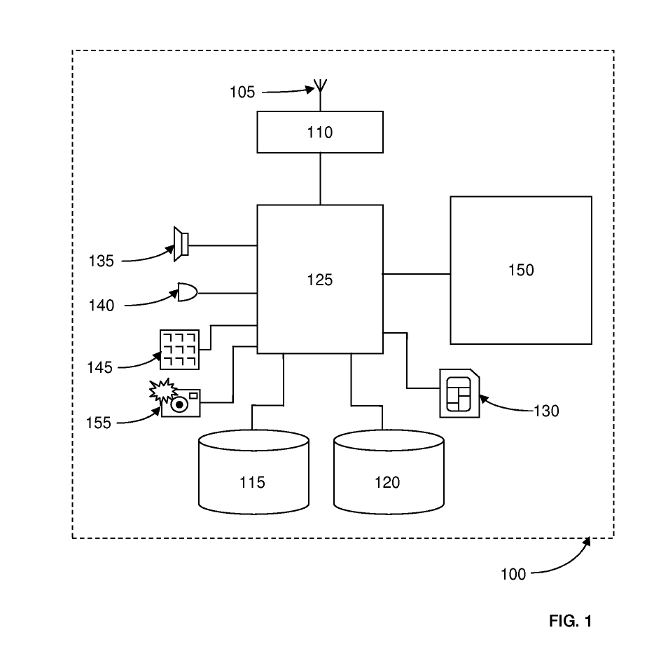

An example embodiment of the present invention and its potential advantages are understood by referring to FIGS. 1 through 14 of the drawings.

FIG. 1 illustrates an apparatus 100 according to an exemplary embodiment of the invention. The apparatus 100 may comprise at least one antenna 105 that may be communicatively coupled to a transmitter and/or receiver component 110. The apparatus 100 also comprises a volatile memory 115, such as volatile Random Access Memory (RAM) that may include a cache area for the temporary storage of data. The apparatus 100 may also comprise other memory, for example, non-volatile memory 120, which may be embedded and/or be removable. The non-volatile memory 120 may comprise an EEPROM, flash memory, or the like. The memories may store any of a number of pieces of information, and data—for example an operating system for controlling the device, application programs that can be run on the operating system, and user and/or system data. The apparatus may comprise a processor 125 that can use the stored information and data to implement one or more functions of the apparatus 100, such as the functions described hereinafter.

The apparatus 100 may comprise one or more User Identity Modules (UIMs) 130. Each UIM 130 may comprise a memory device having a built-in processor. Each UIM 130 may comprise, for example, a subscriber identity module, a universal integrated circuit card, a universal subscriber identity module, a removable user identity module, and/or the like. Each UIM 130 may store information elements related to a subscriber, an operator, a user account, and/or the like. For example, a UIM 130 may store subscriber information, message information, contact information, security information, program information, and/or the like.

The apparatus 100 may comprise a number of user interface components. For example, a microphone 135 and an audio output device such as a speaker 140. The apparatus 100 may comprise one or more hardware controls, for example a plurality of keys laid out in a keypad 145. Such a keypad 145 may comprise numeric (for example, 0-9) keys, symbol keys (for example, #, *), alphabetic keys, and/or the like for operating the apparatus 100. For example, the keypad 145 may comprise a conventional QWERTY (or local equivalent) keypad arrangement. The keypad may instead comprise a different layout, such as E.161 standard mapping recommended by the Telecommunication Standardization Sector (ITU-T). The keypad 145 may also comprise one or more soft keys with associated functions that may change depending on the operation of the device. In addition, or alternatively, the apparatus 100 may comprise an interface device such as a joystick, trackball, or other user input component.

The apparatus 100 may comprise one or more display devices such as a screen 150. The screen 150 may be a touchscreen, in which case it may be configured to receive input from a single point of contact, multiple points of contact, and/or the like. In such an embodiment, the touchscreen may determine input based on position, motion, speed, contact area, and/or the like. Suitable touchscreens may involve those that employ resistive, capacitive, infrared, strain gauge, surface wave, optical imaging, dispersive signal technology, acoustic pulse recognition or other techniques, and to then provide signals indicative of the location and other parameters associated with the touch. A “touch” input may comprise any input that is detected by a touchscreen including touch events that involve actual physical contact and touch events that do not involve physical contact but that are otherwise detected by the touchscreen, such as a result of the proximity of the selection object to the touchscreen. The touchscreen may be controlled by the processor 125 to implement an on-screen keyboard.

The touchscreen is an example of an input-sensing surface. An input sensing surface is any surface that comprises a plurality of locations at which inputs may be received, and the apparatus 100 may comprise other types of input-sensing surface in addition to, or instead of, the touchscreen.

Another example of an input-sensing surface is a radiation-sensitive surface upon which inputs can be made by shining a radiation source, such as a beam of visible or infrared light, on the surface. Another example would be an electronic whiteboard comprising a screen that is receptive to the presence of actual ink or an electronic pen.

The input-sensing surface may be a physical surface (as in the above examples), or it may instead be a virtual surface. A representation on a computer screen (e.g. a representation of a canvas area) may be considered an input-sensing surface if it is possible to make an input at a plurality of areas of that surface (e.g. by moving a cursor to different pixel locations of the surface and pressing a selection button at each one). In this latter case the surface is not a physical surface that actually senses the user input—but it is still a surface at locations on which an input can be sensed, and it is intended that it should therefore fall within the definition of an “input sensing surface”.

The apparatus 100 may comprise a media capturing element such as a video and/or stills camera 155.

Not all of the features of the apparatus 100 illustrated in FIG. 1 need be present, and a non-exhaustive list of examples of the apparatus may therefore include may include a mobile telephone, a personal computer, a Personal Digital Assistant (PDA), a games console, a pager, and a watch. In some embodiments, the apparatus 100 is a mobile communication device.

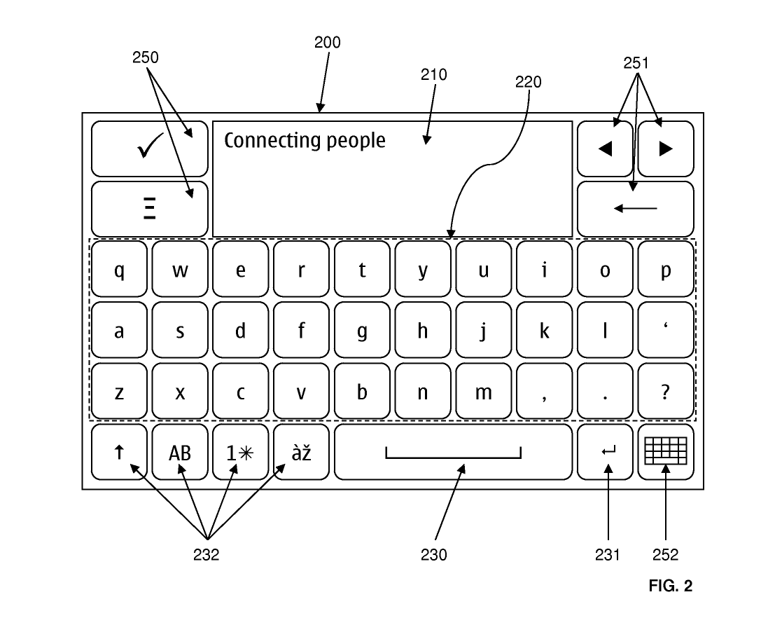

FIG. 2 illustrates a touchscreen 200 that may be used as the display 150 of apparatus 100 and which I displaying a virtual keyboard. This touchscreen 200 and virtual keyboard has been chosen as an example input-sensitive surface, and it is important to understand that it is not necessarily a preferred embodiment, and that the features and methods described in relation to are applicable to other types of input-sensing surfaces than touchscreens and other types of input components than virtual keyboards.

In FIG. 2, the touchscreen 200 is displaying a text area 210 within which text is displayed. This text may have been previously entered by the user, for example. Also displayed on the touchscreen is a virtual keyboard comprising a plurality of alphanumeric keys 220, a spacebar 230 and a carriage return key 231. The keyboard also includes a number of function keys 232, including a shift key, a key for changing the mode in which text is entered (e.g. predictive text, or non-predictive text), a symbol key (for bringing up a menu of selectable numbers and symbols), and a character variant key (for bringing up a similar menu of diacritical characters, foreign characters, and other variants). The keyboard may include all or only some of the keys shown in FIG. 2, and may include additional keys that are not shown. Also shown on the touchscreen 200 are a number of additional function keys 250, 251, 252, the functions of which may include selection between different text input modes (e.g. QWERTY keyboard, ITU-T keyboard, and handwriting recognition), cursor keys, and a delete key. These additional function keys 250, 251, 252 if present may be part of the keyboard of separate from it.

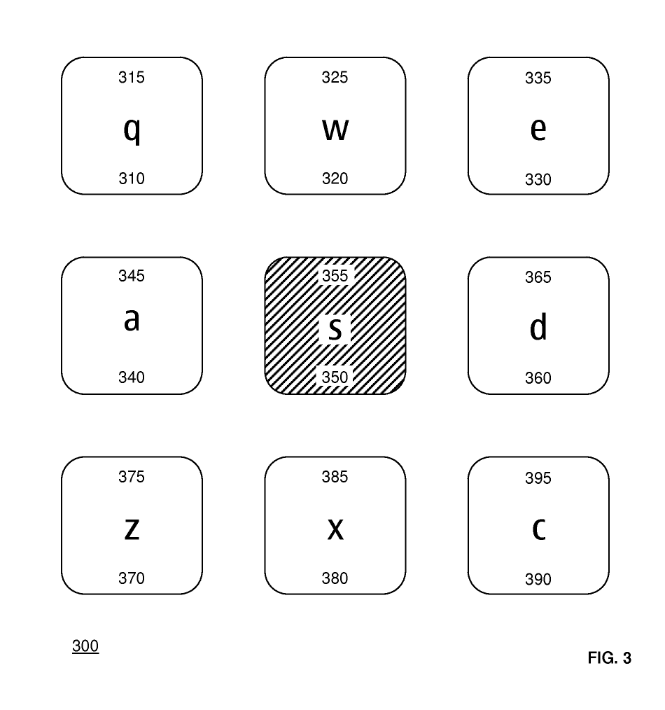

On some input-sensing surfaces the activation of user interface components (e.g. virtual keys, sliders, and scrollbars) is mapped strictly to the location of those components on the input-sensing surface. In a touchscreen the effect of this is that displayed components are manipulated by touch inputs only when they occur in the location of the representation of the component on the screen. For example, FIG. 3 shows nine adjacent alphanumeric keys 300 representing a portion of the virtual keyboard shown in FIG. 2. These are the “q” key 310, the “w” key 320, the “e” key 330, the “a” key 340, the “s” key 350, the “d” key 360, the “z” key 370, the “x” key 380, and the “c” key 390. Each of the keys 310, 320, 330, 340, 350, 360, 370, 380, 390 is associated with an activation area 315, 325, 335, 345, 355, 365, 375, 385, 395 that corresponds to the area of the key's representation on the touchscreen. The activation area 355 of the “s” key 350 has been shaded in diagonal stripes to show its extent, which is the area of the key. A touch input within the activation area of a key is mapped to an activation of that key, so in order to activate the “s” key 350 the user would touch the shaded activation area 355, and this touch input would be mapped to an activation of the key 350.

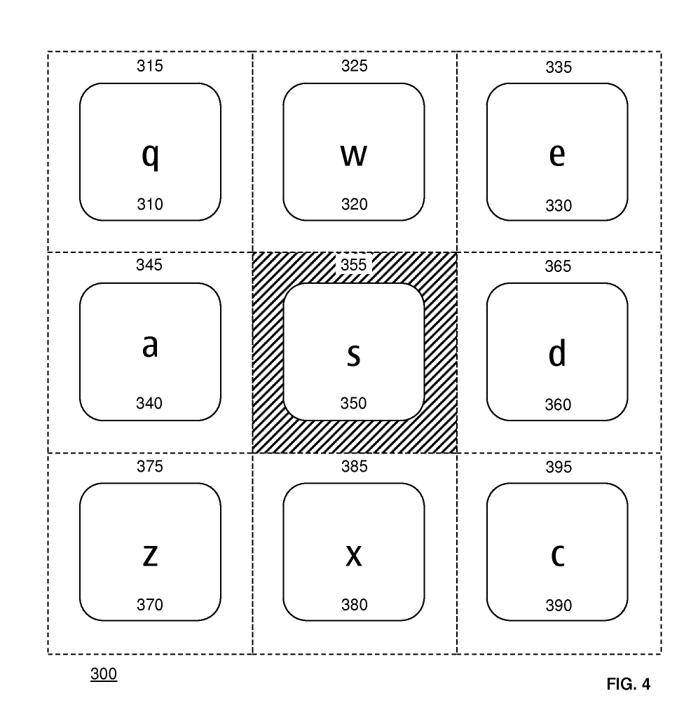

It is not always easy for a user to accurately match his inputs to the activation area of a component. For example, if the representation of the “s” key 350 in FIG. 3 is small on the touchscreen then it may be difficult for the user to make a touch input within it. For example, this may be the case when the user is making a touch input using his fingers rather than a fine stylus. In some examples, it may be easier for the user to activate a component when the activation area is not the same as the area of the representation of the component, for example where the activation area may be larger than the representation of the component. An example of this latter case is shown in FIG. 4, which shows the same portion 300 of the virtual keyboard as FIG. 3, but with the activation areas 315, 325, 335, 345, 355, 365, 375, 385, 395 enlarged.

In FIG. 4 the activation areas 315, 325, 335, 345, 355, 365, 375, 385, 395 are illustrated as dashed boxes surrounding each of the keys 310, 320, 330, 340, 350, 360, 370, 380, 390. The activation area 355 of the “s” key 350 has been shaded using diagonal stripes, to illustrate its extent—touch inputs within this area 355 may be interpreted as an activation of the “s” key 350, with touch inputs in the other activation areas 315, 325, 335, 345, 365, 375, 385, 395 interpreted as activations of the other keys 310, 320, 330, 340, 360, 370, 380, 390.

On occasions, the user may make an input on the input-sensing surface that he intends to be mapped to an activation of one user interface component, but is instead mapped to the activation of a different user interface component because the user's input has been made erroneously outside the activation area of the first input component and within the activation area of the second input component. For example, a user attempting to enter the letter “s” by touching the “s” key 350 of FIG. 4, might accidentally make his touch input to the left of key 350 and inside the activation area 345 corresponding to key 320—the “a” key. In this case, correction of the user input would be necessary to replace the erroneous “a” input with the intended “s” input, i.e. the erroneous activation of key 340 with the intended activation of key 350. Such a correction may be made automatically, or it may be made manually by the same or a different user.

In examples where the correction is made manually, this may be done by performing a user action to reverse the effect of the erroneous activation, and then performing the correct activation. For example, in a case where a wrong character has been input as the result of a user touching the wrong character key in a virtual keyboard, this may be reversed by touching a “delete” key, and then touching the correct character key.

In examples where the correction is performed automatically, this may be the result of monitoring current user input in order to predict expected future user input, and replacing the future user input with the expected user input should they not correspond. For example, some text input systems use a predictive text engine to anticipate the likely next one or more characters based on previously entered characters, for example by comparing the entered characters to previous user inputs, or to a dictionary or other language model. For example, when the user has entered the characters “connectin” it may be predicted with a reasonable level of certainty that the next character will be “g”, because the English language contains no other words with the prefix “connectin”. Should the user enter “h” as the next character, this might be automatically to “g” on the basis that “g” was the predicted next letter. The close proximity of “g” and “h” on the QWERTY keyboard may be used as a supporting measure in the automatic correction.

Predictive text engines may be used to provide automatic corrections at the moment the user makes an erroneous input. However, it is also possible to perform automatic corrections retrospectively. Suppose the user had entered the text “Nokia: connectinh people”, erroneously entering “h” in place of “g”. Subsequently, a spellchecking engine may be used to compare the entered text to a dictionary or other language model in order to identify and correct the error.

Retrospective correction can be performed using manual correction techniques also. In the example above, the user having entered “Nokia: connectinh people” may notice his error and manually return to the erroneous “h” and replace this with a “g”.

Regardless of the particular correction technique used, the fact that there has been a correction made can be used to adapt the user interface in order to minimise future errors. This is based on the reception of a correction, be that a manual correction or an automatic correction.

In some embodiments, the user interface is only adapted when it is used with automatic correction features disabled, and the automatic correction features are otherwise relied upon to handle erroneous inputs. An example of a use case where automatic correction features may be necessarily disabled is the entry of a password or completion of another text field (e.g. a URL) which may not correspond to a known language model.

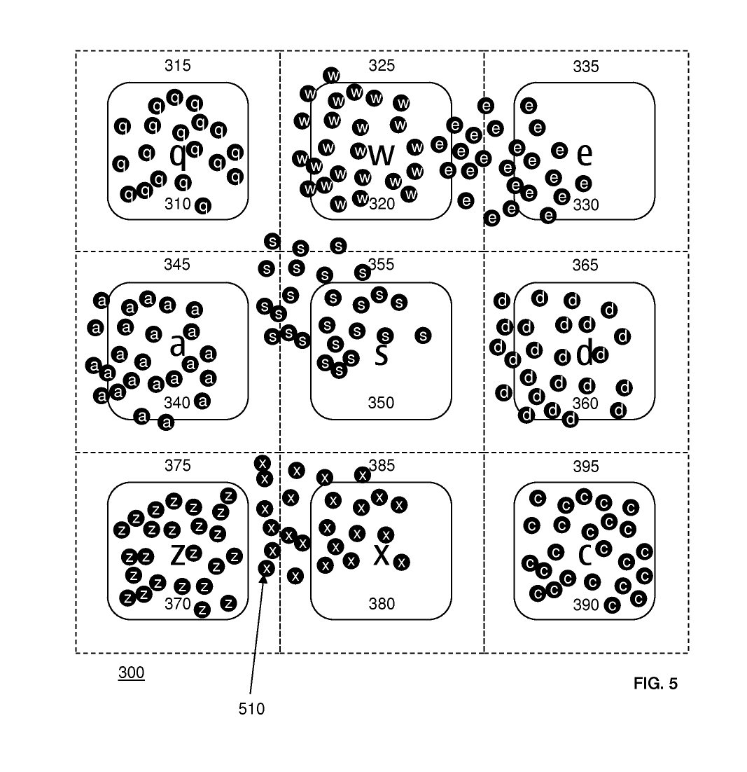

FIG. 5 illustrates the keyboard portion 300 shown in FIG. 4, superimposed with black circles (e.g. 510) containing a character. Each of the black circles represents the location of a user input with the character shown inside being the user's intended selection when he made the input.

For example, input 510 was made with the intention of pressing the “x” key 380, but the user has accidentally touched the touchscreen outside the activation area 385 for the “x” key 380, and inside the activation area 375 for the “z” key 370. If left uncorrected, the resulting activation would be of the “z” key 370 and no the “x” key.

By examining when corrections are made and what the correction is, it is possible to determine the intention of the user when each of the inputs was made. For example, because the user has corrected input 510 to “x”, we know that it was intended to be an activation of the “x” key 580 even though it lies outside the activation area 585 for that key. Conversely, when an input is received within the activation area of a key and no correction is received, the user can be assumed to have intended to activate that key (i.e. there is no error).

In the example of FIG. 5, the user is accurate when entering “q”, “z”, and “c” with all of the inputs for these keys fall within not just the correct activation area 315, 375, 395 but the correct key itself 310, 370, 390. No corrections have been made for these inputs.

The user is less accurate when entering “w”, “a”, and “d”, however whilst not all of the inputs fall on the correct key 320, 340, 360 they do all fall within the correct activation area 325, 345, 365 and consequently no corrections have been made.

The user is less accurate when entering “e”, with the inputs for that key 330 extending out of the correct activation area 335 and into the activation area 325 for the “w” key. Each of the “e” inputs falling in the “w” key's activation area 325 represents a correction of the character “w” to “e”.

Similarly, some of the “x” inputs lie outside the “x” key activation area 385 and in the activation area 375 for the “z” key. These inputs correspond to corrections from “z” to

Finally, the “s” inputs are spread between four different input areas, the “s” key activation area 355, the “q” key activation area 315, the “w” key activation area 325, and the “a” key activation area 345. Only those “s” inputs that appear in the “s” key activation area were initially correct, all of the others represent corrections from “q”, “w”, or “a” into “s”.

If data is available for past corrections, it is possible to adapt the user interface to anticipate future errors. This can be done by modifying the activation areas for components based on previous input. The modification can be based on just the locations of corrected inputs, or the locations both of corrected inputs and of inputs that have not been corrected.

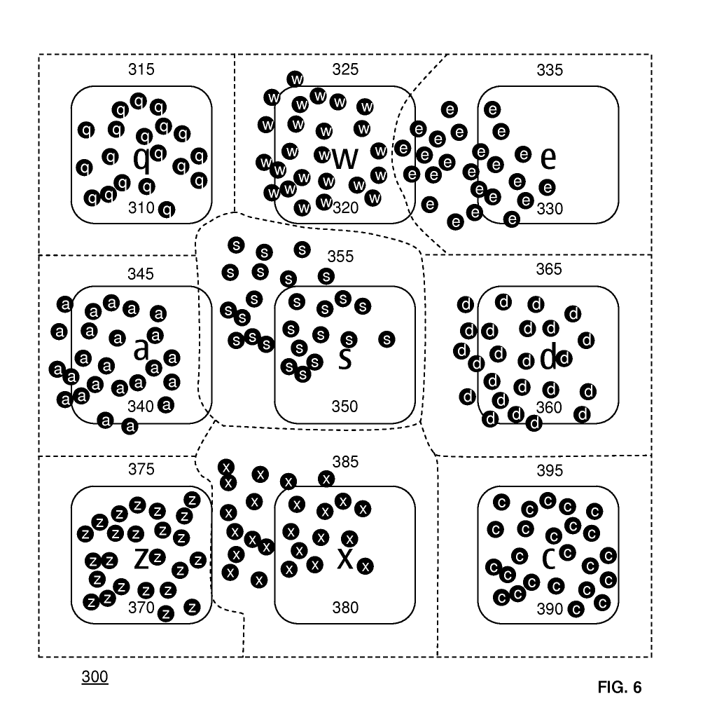

FIG. 6 illustrates an example of an adaptation of the activation areas 315, 325, 335, 345, 355, 365, 375, 385, 395 of FIG. 4 based on the input data shown in FIG. 5. The borders of the activation areas have been distorted to include inputs that have previously required correction. So, for example, the “s” key activation area 355 now extends into up and left into areas that were previously part of the “q”, “w”, and “a” button activation areas 315, 325, 345 because the user has erroneously made “s” inputs at these locations.

Where a first activation area has been stretched into an area formerly occupied by second activation area, the border of the second activation area has been reduced, so that a single input cannot correspond to more than one activation area (and therefore key). In other examples, it may be possible for two activation areas to overlap, in which case an input in the overlapping portion may result in both the associated input components being activated.

In the example shown in FIG. 6, the activation area 335 for the “e” key 330 has been extended over the “w” key 320. The activation area 355 for the “s” button 350 has similarly been extended over the “a” key 340. Consequently, touching the “w” or “a” keys 320, 340 no longer guarantees that that key is activated—instead the “e” or “s” keys 330, 350 may be activated depending on where the key is touched. In some embodiments it is not allowed for an activation area for one component to overlap a representation of another component in this way to avoid user interface behaviour that may be unexpected to the user.

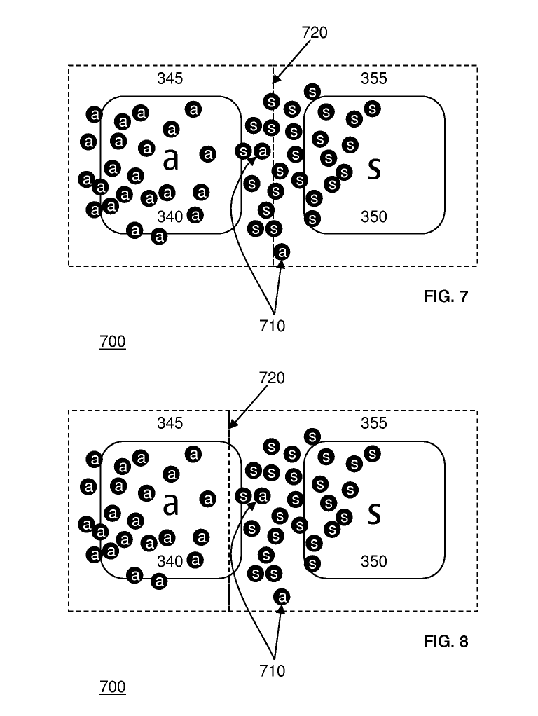

FIG. 6 illustrates an example where the inputs for two components don't overlap, that is to say that it is possible to position the activation areas so that each area is continuous and includes past inputs relating to only its associated input component. However, it may be the case that inputs relating to two components overlap. An example of such an overlapping case is shown in FIG. 7, which illustrates a portion 700 of the virtual keyboard that includes just the “a” and “s” keys 340, 350 and their associated activation areas 345, 355 as in FIG. 4.

A number “a” and “s” inputs are illustrated in FIG. 7—note that these represent a different set of inputs to those illustrated in FIG. 6 and therefore appear at different positions—this is to demonstrate the overlapping input case.

In FIG. 7 the division between the activation areas 345, 355 for the two keys 340, 350 is the dotted line labelled 720. Any “s” inputs to the left of this line 720, or “a” inputs to the right of it, have therefore been corrected.

FIG. 8 illustrates an adapted configuration of the activation areas 345 355 in FIG. 7 in which the border 720 between the activation areas has been moved to the left in order that all “s” inputs are contained within the “s” key activation area 355. However, the “a” and “s” inputs overlap, with the effect that two “a” inputs 710 now lie within the “a” key activation area 345. This arrangement of activation areas may be satisfactory because the number (or proportion) of corrected “s” inputs would now be covered by the new “s” key activation area 355 is much larger than the number (or proportion) of “a” inputs (both corrected or initially correct) that don't fall within the new “a” key activation area 345, and the number of expected future errors will therefore have been reduced.

There are many different techniques in which the past input data, including the correction data, can be used to allocate activation areas for input components and whilst specific examples may be explained herein, the particular choice of technique will depend on the use case in which it is required.

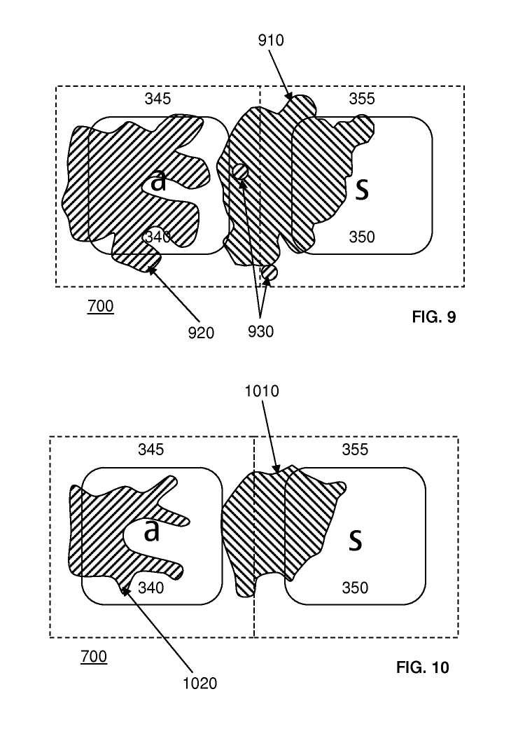

FIG. 9 illustrates an example of a technique through which the boundaries of the activation areas may be set. First of all, the input density across the input-sensing surface (in this case, the touchscreen) is calculated for each user interface component. The input density may be calculated as a function of the number of inputs (corrected, or initially correct) that correspond to each user interface component. The activation areas of the user interface components may be chosen so that they include those areas where the input density is above a threshold value, a high enough threshold being chosen to eliminate individual outlying inputs from the final areas. In FIG. 9 there are only two components illustrated, the “a” and “s” keys 340, 350, and their input densities above a first threshold value are illustrated by shaded areas 910 (for “s” inputs), and 920 and 930 (for “a” inputs). The “a” inputs include outliers represented by islands 930, and it may be desirable that these are eliminated in order that continuous non-overlapping activation areas can be assigned to the keys 340, 350.

In order to eliminate the outlying islands 930, the threshold density is increased, with the effect of reducing the shaded areas to 1010, 1020 as shown in FIG. 10. The outlying islands 930 has disappeared and the activation areas 345 355 can be adjusted by moving the border between them 720 further to the left as shown.

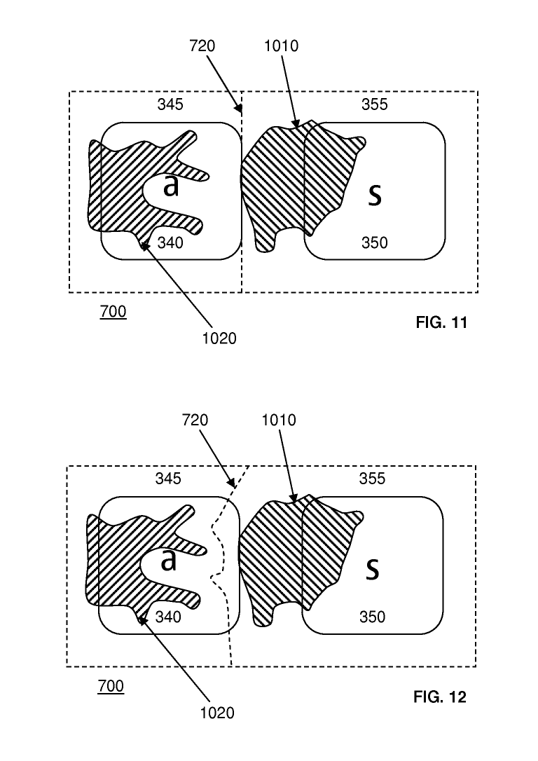

In FIG. 10, a straight border 720 has been chosen that does not encroach upon the “a” key. Different heuristics for selecting the border based on the input densities might result in a curved border 720 that is equidistant from the edges of the shaded areas 1010, 1020 and therefore encroaches upon the “a” key as shown in FIG. 11.

Other adjustments to the activation areas are also possible, and the selection of a technique will depend on the use case in which it is to be applied.

It is not necessarily the case that the activation area associated with a component is continuous, however in some embodiments this may be made a heuristic of the technique used to determine the activation areas in order to simplify the interface for the user, particularly as the extent of the activation areas in many embodiments will not be presented to him.

In the above examples, the borders of the activation areas have been adjusted based on the input data (including the correction data) in such a way that they may end up a different shape to that in which they were initially. However, in some embodiments, the dimensions of the activation area do not change, and instead the area is translated in the direction of the highest input density (or according to another heuristic). An example of this is illustrated in FIG. 12, which shows the activation areas 315, 325, 335, 345, 355, 365, 375, 385, 395 of FIG. 3 having undergone such translation.

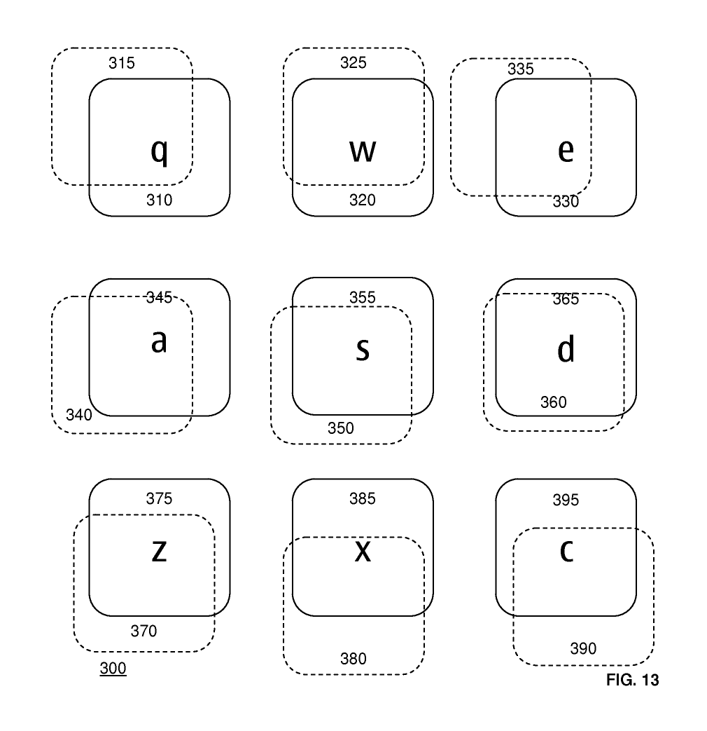

In some embodiments, such as that of FIG. 13, where a translation is applied to an activation area, the direction and displacement of the translation may be used in other features of the user interface. For example, all subsequent user inputs anywhere on the input-sensitive surface may be remapped according to the inverse translation, working on the assumption that they will all be affected by a similar erroneous offset. Alternatively, the inverse translation may only be applied to subsequent inputs that fall within the bounds of the translated activation area—even after the input component is no longer in use.

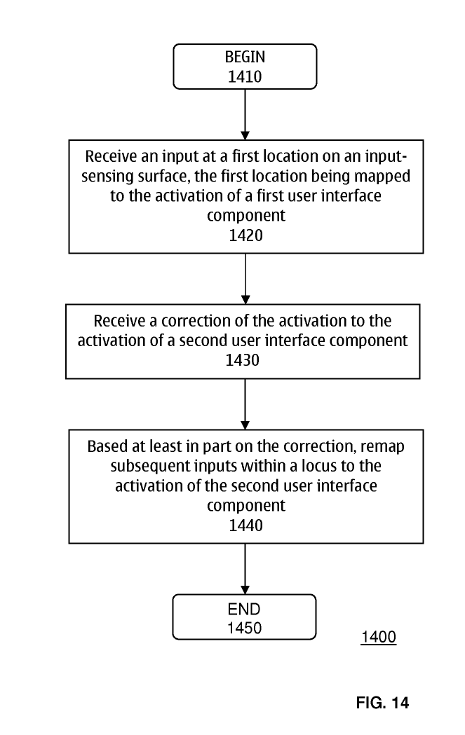

FIG. 14 illustrates a method 1400 for performing the above-described adjustment of a user interface. The method 1400 begins at 1410.

Firstly, an input is received 1420 at a first location on an input-sensing surface, the first location being mapped to the activation of a first user interface component. The location of the input is in fact erroneous, however since it is received at a location that is mapped to the first user interface component, in some embodiments it will result in the first user input component being activated. In other embodiments, the input will be detected as erroneous and the first input component will not actually be activated. Whether the first input is actually activated or corrected prior to activation, a correction is received 1430 correcting the actual or potential activation of the first input element to the activation of a second user interface component to which the input was intended to correspond. Based at least in part on the correction, subsequent inputs within a locus are remapped 1440 to the activation of the second user interface component. The locus may be, for example, an area that was previously mapped to the second user interface component (it's “activation area”) and has been updated based on at least the correction. In some embodiments, the updating may be based on inputs that were initially correct in addition to corrections, and the locus may include the first location. The method then ends 1450.

Without in any way limiting the scope, interpretation, or application of the claims appearing below, a technical effect of one or more of the example embodiments disclosed herein is that a user will experience fewer erroneous user inputs when using an input-sensing surface.

Embodiments of the present invention may be implemented in software, hardware, application logic or a combination of software, hardware and application logic. The software, application logic and/or hardware may reside on a removable memory, within internal memory or on a communication server. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with examples of a computer described and depicted in FIG. 1. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method comprising:
receiving an input at a first location on an input-sensing surface, the first location being mapped to the activation of a first user interface component;
receiving a correction of the activation to the activation of a second user interface component; and
based at least in part on the correction, remapping subsequent inputs within a locus to the activation of the second user interface component.

2. The method of claim 1, wherein the locus comprises the first location.

3. The method of claim 1, wherein:
the second user interface component comprises an activation area on the input-sensing surface; and
the mapping comprises including the locus within the second user interface's activation area.

4. The method of claim 1, wherein the input-sensing surface is a touchscreen.

5. The method of claim 1, wherein the first and second input elements are virtual keys.

6. The method claim 1, wherein the subsequent inputs are only remapped whilst an automatic correction mode is not inactive.

7. The method of claim 1, wherein the remapping is further based on previous inputs that have been mapped to the activation of the second user input component.

8. An apparatus comprising:
a processor; and
memory including computer program code,
the memory and the computer program code configured to, working with the processor, cause the apparatus to perform at least the following:
receive an input at a first location on an input-sensing surface, the first location being mapped to the activation of a first user interface component;
receive a correction of the activation to the activation of a second user interface component; and
based at least in part on the correction, remap subsequent inputs within a locus to the activation of the second user interface component.

9. The apparatus of claim 8, wherein the locus comprises the first location.

10. The apparatus of claim 8, wherein:
the second user interface component comprises an activation area on the input-sensing surface; and
the mapping comprises including the locus within the second user interface's activation area.

11. The apparatus of claim 8, wherein the input-sensing surface is a touchscreen.

12. The apparatus of claim 8, wherein the first and second input elements are virtual keys.

13. The apparatus of claim 8, wherein the subsequent inputs are only remapped whilst an automatic correction mode is not inactive.

14. The apparatus of claim 8, wherein the input-sensing surface is a touchscreen comprised by the apparatus.

15. The apparatus of claim 14, being a mobile communication device.

16. A computer program product comprising a computer-readable medium bearing computer program code embodied therein for use with a computer, the computer program code comprising:
code for receiving an input at a first location on an input-sensing surface, the first location being mapped to the activation of a first user interface component;
code for receiving a correction of the activation to the activation of a second user interface component; and
code for, based at least in part on the correction, remapping subsequent inputs within a locus to the activation of the second user interface component.
